(19) United States
(12) Patent Application Publication
(10) Pub. No.: US 2026/0054580 A1
(43) Pub. Date: Feb. 26, 2026

(54) Battery Control System and Battery Control Method

(71) Applicant: SK On Co., Ltd., Seoul (KR)

(72) Inventors: Jeong Joo LEE, Daejeon (KR); Tak Kyung YOO, Daejeon (KR); Soo Hwan JO, Daejeon (KR); Kwang Hwan HAN, Daejeon (KR)

(21) Appl. No.: 19/246,992

(22) Filed: Jun. 24, 2025

(30) Foreign Application Priority Data
Aug. 21, 2024 (KR) 10-2024-0112013

(51) Int. Cl. B60L 50/60; B60L 58/13; B60L 58/18

(52) U.S. Cl. CPC B60L 50/60; B60L 58/13; B60L 58/18; B60L 2240/545; B60L 2240/547

(57) ABSTRACT

A battery control system according to the present disclosure includes a high-voltage output portion including a plurality of battery cells, a plurality of sensing units formed by grouping a portion of the plurality of battery cells into a predetermined number of groups, and a plurality of low-voltage units formed by grouping another portion of the plurality of battery cells into a predetermined number of groups, except for the plurality of sensing units, a switching portion connecting the plurality of low-voltage units and a first external device, and a control portion changing one of the plurality of sensing units to another sensing unit, or changing one of the plurality of low-voltage units to another low-voltage unit, based on at least one of a voltage, a capacity, and a usage time of the plurality of battery cells, wherein the plurality of sensing units supply power to a second external device.

### CROSS-REFERENCE TO RELATED PATENT APPLICATION

The present application claims priority under 35 U.S.C. § 119(a) to Korean patent application number 10-2024-0112013 filed on Aug. 21, 2024 in the Korean Intellectual Property Office, the entire disclosed portion of which is incorporated by reference herein.

### BACKGROUND OF THE INVENTION

### 1. Field

The present disclosure relates to a battery control system and a battery control method.

### 2. Description of the Related Art

A vehicle may include a low-voltage battery to power electronics in the vehicle and a high-voltage battery to run a motor or an engine of the vehicle. However, the vehicle equipped with both low-voltage and high-voltage batteries increases structural complexity, weight, and assembly process difficulty. Therefore, extensive research is being conducted to efficiently control batteries inside the vehicle.

### SUMMARY OF THE INVENTION

An aspect of the present disclosure is to provide a battery control system and a battery control method that reduce the weight of a vehicle and improve performance.

In addition, the present disclosure may be widely applied in the fields of electric vehicles, battery charging stations, and other green technologies such as photovoltaics and wind power using batteries.

In addition, the present disclosure may be used in eco-friendly electric vehicles and hybrid vehicles to prevent climate change by suppressing air pollution and greenhouse fluid emissions.

A battery control system according to embodiments of the present disclosure may include a high-voltage output portion including a plurality of battery cells, a plurality of sensing units formed by grouping a portion of the plurality of battery cells into a predetermined number of groups, and a plurality of low-voltage units formed by grouping another portion of the plurality of battery cells into a predetermined number of groups, except for the plurality of sensing units, a switching portion connecting the plurality of low-voltage units and a first external device, and a control portion changing one of the plurality of sensing units to another sensing unit, or changing one of the plurality of low-voltage units to another low-voltage unit, based on at least one of a voltage, a capacity, and a usage time of the plurality of battery cells, wherein the plurality of sensing units supply power to a second external device different from the first external device.

The control portion may change one of the plurality of sensing units to another sensing unit, or may change one of the plurality of low-voltage units to another low-voltage unit when a voltage deviation of the plurality of battery cells is greater than or equal to a reference value.

The control portion may determine whether a minimum voltage cell having a lowest voltage among the plurality of battery cells is included in the plurality of sensing units.

The control portion may change a sensing unit to which the minimum voltage cell with a lowest voltage among the plurality of battery cells belongs to another sensing unit to supply power to the first external device when the minimum voltage cell belongs to the plurality of sensing units.

The control portion may change the sensing unit to which the minimum voltage cell belongs to another sensing unit according to a predetermined sensing unit changing order.

The control portion may change a low-voltage unit to which the minimum voltage cell with the lowest voltage among the plurality of battery cells to another low-voltage unit to supply power to the second external device when the minimum voltage cell belongs to the plurality of low-voltage units.

The control portion may change the low-voltage unit to which the minimum voltage cell belongs to another low-voltage unit according to a predetermined low-voltage unit changing order.

A battery control method of a battery control system including a high-voltage output portion including a plurality of battery cells; a plurality of sensing units formed by grouping a portion of the plurality of battery cells into a predetermined number of groups□ a plurality of low-voltage units formed by grouping another portion of the plurality of battery cells into a predetermined number of groups, except for the plurality of sensing units; a switching portion connecting the plurality of low-voltage units and a first external device; and a control portion changing one sensing unit among the plurality of sensing units to another sensing unit, or changing one low-voltage unit among the plurality of low-voltage units to another low-voltage unit, based on at least one of a voltage, a capacity, and a usage time of the plurality of battery cells, wherein the plurality of sensing units supply power to a second external device different from the first external device, may include supplying power to the first external device by the one low-voltage unit among the plurality of low-voltage units, supplying power to the second external device by the one sensing unit among the plurality of sensing units, and changing the one low-voltage unit connected to the first external device to another low-voltage unit, or changing the one sensing unit connected to the second external device to another sensing unit, based on at least one of a voltage, a capacity, and a usage time of the plurality of battery cells.

The changing may include: determining whether a voltage deviation of the plurality of battery cells is greater than or equal to a reference value, sensing a minimum voltage cell having a lowest voltage among the plurality of battery cells, and determining whether the minimum voltage cell is included in the plurality of sensing units.

The changing may further include changing a sensing unit to which the minimum voltage cell belongs to another sensing unit when the minimum voltage cell is included in the plurality of sensing units.

The changing may include changing the sensing unit to which the minimum voltage cell belongs to another sensing unit according to a predetermined sensing unit changing order.

The changing may further include changing a low-voltage unit to which the minimum voltage cell belongs to another sensing unit when the minimum voltage cell is included in the plurality of low-voltage units.

The changing may include changing a low-voltage unit to which the minimum voltage cell belongs to another low-voltage unit according to a predetermined low-voltage unit changing order.

### BRIEF DESCRIPTION OF THE DRAWINGS

FIG. 1 schematically illustrates a battery control system according to an embodiment of the present disclosure.

FIG. 2 is a block diagram of a battery control system according to an embodiment of the present disclosure.

FIG. 3 schematically illustrates a battery control system according to another embodiment of the present disclosure.

FIGS. 4 and 5 schematically illustrate a battery control method according to an embodiment of the present disclosure.

### DETAILED DESCRIPTION

Hereinafter, the present disclosure will be described in detail with reference to the accompanying drawings. This is, however, illustrative only and not intended to limit the disclosed portion to the specific embodiments illustratively described.

The specific terms used herein are for convenience of description only and are not intended to be limiting exemplary embodiments.

For example, expressions such as “same” and “being same” indicate not only a state in which they are strictly the same, but also a state in which there is a tolerance or a difference in the degree to which the same function is obtained.

For example, expressions indicating relative or absolute arrangement such as “in a direction,” “along a direction,” “in parallel,” “vertically,” “centrally,” “concentrically,” or “coaxially” not only strictly indicate such arrangements, but also indicate a state of relative displacement with tolerances or an angle or distance to the extent that the same function is obtained.

To explain the present disclosure, descriptions below may be based on a spatial orthogonal coordinate system with X, Y, and Z axes orthogonal to each other. Each axis direction (X-axis direction, Y-axis direction, Z-axis direction) refers to both directions in which each axis extends.

The X-direction, Y-direction, and Z-direction mentioned below are for the purpose of explanation, so that the present disclosure may be clearly understood. The directions may be defined differently depending on where the reference is placed.

The use of terms such as ‘first, second, and third’ in front of the components mentioned below is only to avoid confusion about the components to which they are referred and is irrelevant to the order, importance, or master-slave relationship between the components, etc. For example, an embodiment that includes only a second component without a first component may also be implemented.

It is also to be understood that the terminology used herein is used for the purpose of describing particular embodiments only, and is not intended to limit the scope of the present invention. It must be noted that as used herein and in the appended claims, the singular forms “a,” “an,”and “the”include the plural reference unless the context clearly dictates otherwise.

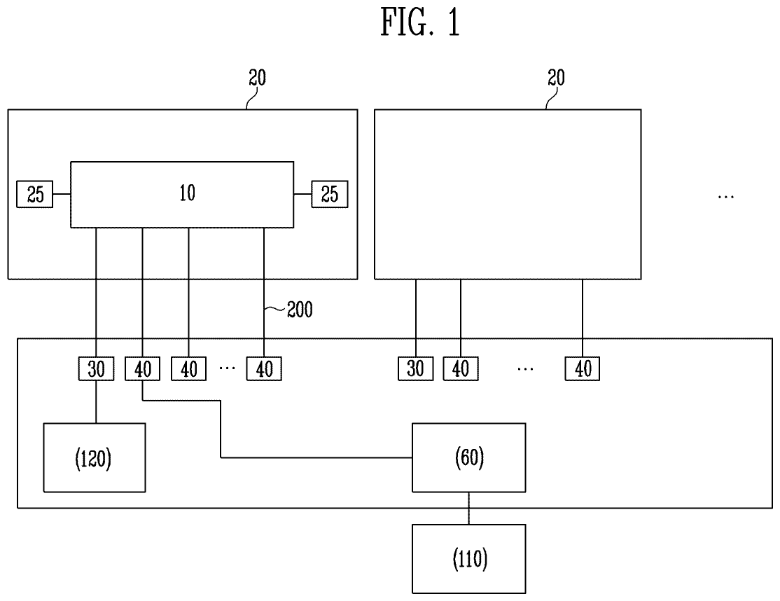

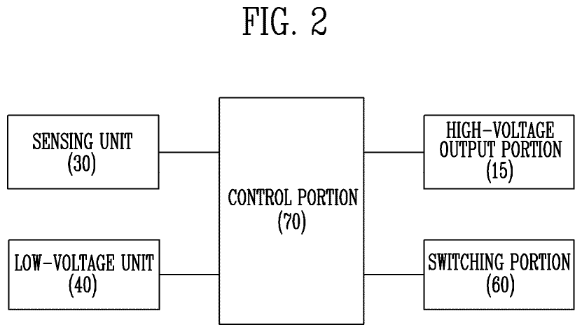

FIG. 1 schematically illustrates a battery control system according to an embodiment of the present disclosure, and FIG. 2 is a block diagram of a battery control system according to an embodiment of the present disclosure.

A battery control system of the present disclosure includes a high-voltage output portion 15 including a plurality of battery cells 10; a plurality of sensing units 30 formed by grouping some of the plurality of battery cells 10 in a predetermined number and a plurality of low-voltage units 40 formed by grouping other portions of the plurality of sensing units 30 in a predetermined number; a switching portion 60 connecting the plurality of low-voltage units 40 to a first external device 110; and a control portion 70 changing one of the plurality of sensing units 30 to another sensing unit 30, or changing one of the plurality of low-voltage units 40 to another low-voltage unit 40, based on at least one of a voltage, a capacity, and a usage time of the plurality of battery cells 10. The plurality of sensing units 30 supply power to the first external device 110 and a second external device 120 different from the first external device 110.

The battery cell 10 may refer to a secondary battery which may be used repeatedly by charging and discharging electrical energy. In one example, the secondary battery may refer to a lithium secondary battery or a lithium-ion battery, but the present disclosure is not limited thereto. As another example, the secondary battery may refer to a solid-state battery.

The high-voltage output portion 15 includes the plurality of battery cells 10. The plurality of battery cells 10 may have a predetermined voltage. The plurality of battery cells 10 may be at least partially connected in series. Thus, the high-voltage output portion 15 may have a high voltage.

The high-voltage output portion 15 may be used to drive an automotive motor. The voltage of the high-voltage output portion 15 may vary depending on the type of motor and operating conditions of the motor. In an embodiment, the high-voltage output portion 15 may have a voltage of 100 V to 200 V.

The plurality of battery cells 10 may be grouped in a predetermined number of groups. The grouped battery cells 10 may be received in a case to form a plurality of battery modules 20. The plurality of battery modules 20 may each include a connection terminal. Each of the battery modules 20 may be connected to the motor of an external device (e.g., a motor of an automobile) to supply power. In other words, the high-voltage output portion 15 may be grouped into the plurality of battery modules 20 formed by grouping the plurality of battery cells 10.

On the other hand, vehicle batteries need to power vehicle electronics (e.g., displays, headlights, etc.). A low-voltage output portion may be provided separately from the high-voltage output portion to supply power to the vehicle electronics. However, separate high-voltage and low-voltage output portions may result in inefficient use of interior space, reduced structural stability, and reduced production efficiency.

The present disclosure may not include a separate battery for the low-voltage output portion. The present disclosure may utilize the plurality of battery cells 10 included in the high-voltage output portion to power the vehicle electronics. That is, the battery in the high-voltage output portion may not only be used to drive the vehicle, but may also supply power to the interior of the vehicle.

The present disclosure includes the plurality of sensing units 30 formed by grouping some of the plurality of battery cells 10 into a predetermined number of groups. The present disclosure also includes the plurality of low-voltage units 40 formed by grouping other battery cells 10, except for the plurality of sensing units 30, into a predetermined number of groups.

The low-voltage unit 40 may provide power to the first external device 110. In an embodiment, the first external device 110 may refer to a vehicle electronic device. That is, the vehicle electronic device may be operated by the low-voltage unit 40. The sensing unit 30 may provide power to the second external device 120. In an embodiment, the second external device 120 may be a battery management system. That is, the sensing unit 30 may operate the battery management system. The battery management system may sense and control a state of the battery. For example, the battery management system may sense a state of charge of the battery cell 10, the voltage of the battery cell 10, the temperature of the battery cell 10, and the like, and may control a charging rate of the battery cell 10.

Even when the high-voltage output portion 15 includes the plurality of sensing units 30 and the plurality of low-voltage units 40, a drive portion needs to be continuously supplied with power. Thus, the plurality of sensing units 30 may be connected in parallel with the plurality of battery cells 10, and the plurality of low-voltage units 40 may also be connected in parallel with the plurality of battery cells 10.

Referring to FIG. 1, the high-voltage output portion 15 may include the plurality of battery modules 20. The plurality of battery modules 20 may each include the plurality of battery cells 10 and a terminal portion. The battery modules 20 may be electrically connected to the outside via the terminal portions. Some of the plurality of battery cells 10 may be connected in series so that each battery module 20 may have a high voltage.

The sensing unit 30 may be connected in parallel with some of the plurality of battery cells 10 connected in series. The connection of the low-voltage unit 40 may not affect the voltage of the battery module 20. For the same reason, the low-voltage unit 40 may also be connected in parallel with some of the plurality of battery cells 10 connected in series.

The number of battery cells 10 grouped into the sensing unit 30 or the low-voltage unit 40 may vary depending on the operating environment. The sensing unit 30 may be formed by grouping some of the plurality of battery cells 10 and electrically connecting the battery cells 10 so as to obtain a voltage magnitude corresponding to the second external device 120.

The low-voltage unit 40 may also be formed by grouping some of the plurality of battery cells 10 and electrically connecting the battery cells 10 to have a voltage magnitude corresponding to the first external device 110. For example, when the first external device 110 has a rated voltage of 12 V, the number of battery cells 10 may be set so that the low-voltage unit 40 may form a voltage of 12 V, and the battery cells 10 may be electrically connected.

In an embodiment, each battery module 20 may include one sensing unit 30 and the plurality of low-voltage units 40. The voltage of the sensing unit 30 and the voltage of the low-voltage unit 40 may vary in magnitude. The voltages of the plurality of low-voltage units 40 may all have the same magnitude.

The sensing unit 30 may be connected to the second external device 120. The low-voltage unit 40 may be connected to the first external device 110 by the switching portion 60. The switching portion 60 may change the low-voltage unit 40 connected to the first external device 110 to another low-voltage unit 40.

The control portion 70 may change one sensing unit 30 of the plurality of sensing units 30 to another sensing unit 30, or may change one low-voltage unit 40 of the plurality of low-voltage units 40 to another low-voltage unit 40, based on at least one of a voltage, a capacity, and a usage time of the plurality of battery cells 10. Referring to FIG. 2, the control portion 70 may control each of the high-voltage output portion 15, the sensing unit 30, the low-voltage unit 40, and the switching portion 60.

Some of the plurality of battery cells 10 may be used in the high-voltage output portion 15 and at the same time, may be used as the sensing units 30 or the low-voltage units 40. As a result, some of the battery cells 10 may lose charge faster than the other battery cells 10. In other words, some battery cells 10 may deteriorate faster than the other battery cells 10.

To maintain the performance of the battery, the battery control system of the present disclosure may sense the plurality of battery cells 10 to discontinue use of the deteriorating battery cells 10 and allow other battery cells 10 to replace the deteriorating battery cells 10.

Referring to FIG. 1, the control portion 70 may control such that when the battery cell 10 included in the low-voltage unit 40 connected to the first external device 110 deteriorates, another low-voltage unit 40 may be connected to the first external device 110. The control portion 70 may perform control based on one of the voltage, the capacity, and the usage time of the battery cell 10.

Further, when the low-voltage units 40 belonging to one of the controlled battery modules 20 are exhausted, the low-voltage units 40 belonging to another battery module 20 may be controlled to be used.

In an embodiment, one of the battery modules 20 may include first to 10th low-voltage units 40. First, the first low-voltage unit 40 may supply power to the first external device 110. When the battery cell 10 included in the first low-voltage unit 40 deteriorates, the control portion 70 may cause the second low-voltage unit 40 to supply power to the first external device 110.

One sensing unit 30 may be provided in each battery module 20. First, the sensing unit 30 in each battery module 20 may provide power to the second external device 120. When the battery cell 10 included in the sensing unit 30 in one of the battery modules 20 deteriorates, the control portion 70 may cause the sensing unit 30 in another battery module 20 to supply power to the second external device 120.

The control portion 70 may change one of the plurality of sensing units 30 to another sensing unit 30, or may change one of the plurality of low-voltage units 40 to another low-voltage unit 40 when a voltage deviation of the plurality of battery cells 10 is greater than or equal to a reference value.

The control portion 70 may sense the voltage deviation of the plurality of battery cells 10. When some of the plurality of battery cells 10 deteriorate, the voltage deviation may increase. When the voltage deviation is greater than or equal to a threshold value, the control portion 70 may control the sensing unit 30 and the low-voltage unit 40 to prevent the battery cell 10 from deteriorating. The reference value may be changed depending on the usage environment and operating conditions of the battery.

An error value higher than the reference value may be set. When the voltage deviation of the plurality of battery cells 10 is higher than the error value, the battery may be controlled according to the predetermined method. In an embodiment, when the battery cell 10 is used continuously, the voltage deviation of the battery cell 10 may be greater than the error value due to an overload. Therefore, it may be desirable for the control portion 70 to control the battery cell 10 after the voltage deviation of the plurality of battery cells 10 exceeds the threshold value, but before the voltage deviation exceeds the error value.

The control portion 70 may determine whether a minimum voltage cell with the lowest voltage among the plurality of battery cells 10 is included in the plurality of sensing units 30. The voltage may decrease when the battery cell 10 is overloaded. The minimum voltage cell may indicate the battery cell 10 which has supplied the most power. Therefore, the minimum voltage cell may be sensed to prevent degradation.

The control portion 70 may change the sensing unit 30 including the minimum voltage cell among the plurality of battery cells 10 to another sensing unit 30 so as to supply power to the first external device 110 when the minimum voltage cell with the lowest voltage is included in the plurality of sensing units 30. In this manner, battery performance degradation due to degradation of the minimum voltage cell may be prevented.

Further, the control portion 70 may change the sensing unit 30 to which the minimum voltage cell belongs to another sensing unit 30 in accordance with a predetermined order of changing the sensing units 30. In an embodiment, the predetermined order of changing the sensing units 30 may be set such that after the sensing unit 30 connected to one the plurality of battery modules 20 is used, the sensing unit 30 connected to another battery module 20 may be used.

Each of the sensing units 30 connected to each of the plurality of battery modules 20 may be used once in a predetermined sequence, starting with the first sensing unit 30 which is used for the first time. After each of the sensing units 30 has been used once, the first sensing unit 30 may be used again.

The control portion 70 may change the low-voltage unit 40 including the minimum voltage cell among the plurality of battery cells 10 to another low-voltage unit 40 so as to supply power to the second external device 120 when the minimum voltage cell is included in the plurality of low-voltage units 40. As a result, degradation of the battery performance due to degradation of the minimum voltage cell may be prevented.

Further, the control portion 70 may change the low-voltage unit 40 including the minimum voltage cell to another low-voltage unit 40 in accordance with the predetermined order of changing the low-voltage units 40.

In an embodiment, the predetermined order of changing the low-voltage units 40 may be set such that after the low-voltage units 40 connected to one of the plurality of battery modules 20 is completely used, the low-voltage units 40 connected to another battery module 20 may be used. Further, one of the plurality of low-voltage units 40 connected to one of the battery modules 20, except for the used low-battery unit 40, may be set.

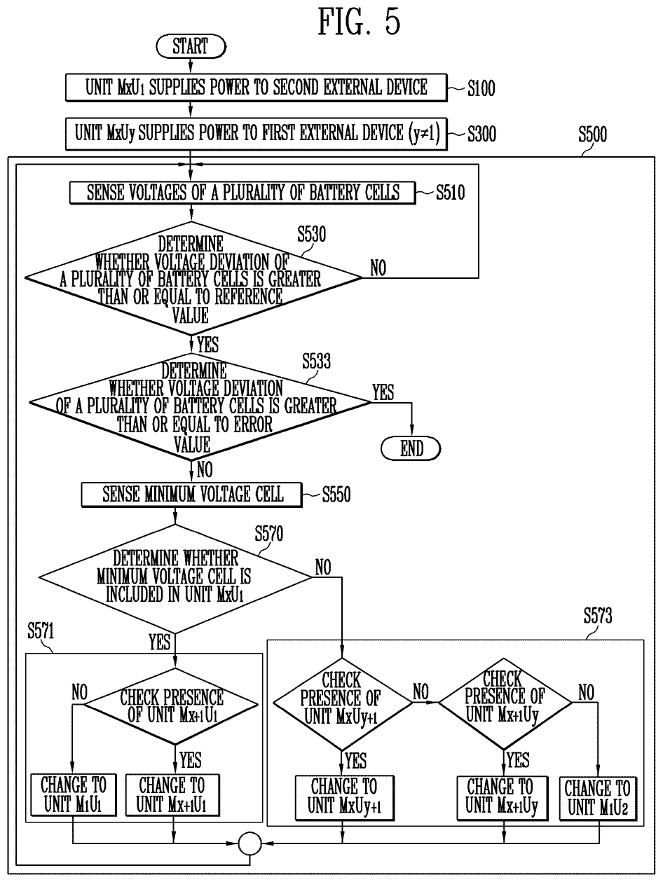

Starting with the initially used low-voltage unit 40, the low-voltage units 40 connected to each of the plurality of battery modules 20 may be used once in a predetermined sequence. After all of the low-voltage units 40 have been used once, the low-voltage unit 40 which is used for the first time may be used again. The order of changing the sensing units 30 and the order of changing the low-voltage units 40 will be described in detail with reference to FIG. 5.

A low-voltage line 200 may electrically connect the battery management system and the plurality of battery cells 10 so as to sense the state of the plurality of battery cells 10 and control the battery cells 10. Referring to FIG. 1, the sensing units 30 and the low-voltage units 40 may be connected to each of the plurality of battery cells 10 via the low-voltage line 200. In this manner, the design may be simplified since there is no need to branch a separate circuit.

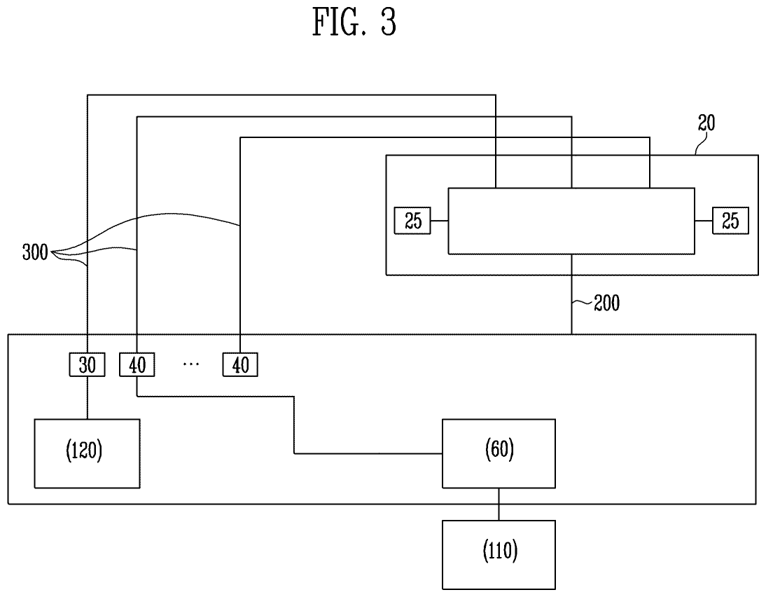

FIG. 3 schematically illustrates a battery control system according to another embodiment of the present disclosure.

In another embodiment, the present disclosure may include a power line 300 which branches separately from the low-voltage line 200. The power line 300 may connect each of the plurality of battery cells 10 to the sensing units 30 and the low-voltage units 40, respectively. Referring to FIG. 3, one of the battery modules 20 may be electrically connected to the battery management system by the low-voltage line 200 and the power line 300. Though not shown in FIG. 3, another battery module 20 may also have the low-voltage line 200 and the power line 300, by which the battery module 20 may be electrically connected to the battery management system.

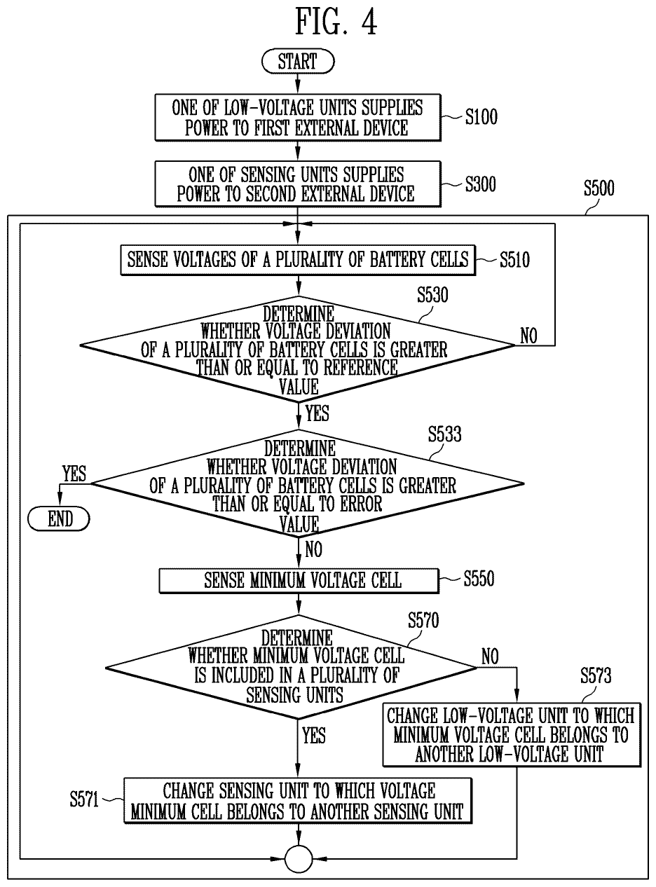

FIGS. 4 and 5 schematically illustrate a battery control method according to an embodiment of the present disclosure.

According to the battery control method of the present disclosure, one of the plurality of low-voltage units 40 supplies power to the first external device 110 at step S100; one of the plurality of sensing units 30 supplies power to the second external device 120 at step S300; and the one low-voltage unit 40 connected to the first external device 110 is changed to another low-voltage unit 40, or the one sensing unit 30 connected to the second external device 120 is changed to another sensing unit 30, based on at least one of a voltage, a capacity, and a usage time of the plurality of battery cells 10 at step S500.

Referring to FIG. 4, the present disclosure may perform step S500 after step S100 in which the low-voltage unit 40 supplies power to the first external device 110 and step S300 in which the sensing unit 30 supplies power to the second external device 120. Step S100 of supplying power to the first external device 110 and step S300 of supplying power to the second external device 120 may be performed simultaneously or separately.

Step S500 of the present disclosure may further include determining whether the voltage deviation of the plurality of battery cells 10 is greater than or equal to a reference value at step S530, sensing a minimum voltage cell having the lowest voltage among the plurality of battery cells 10 at step S550, and determining whether the minimum voltage cell is included in the plurality of sensing units 30 at step S570.

Step S500 of the present disclosure may further include step S510 of sensing voltages of the plurality of battery cells 10. After step S510 of sensing the voltages, step S530 of determining whether the voltage deviation of the plurality of battery cells greater than or equal to a reference value may be performed.

According to the present disclosure, after determining whether the voltage deviation of the plurality of battery cells 10 is greater than or equal to the reference value, a minimum voltage cell having the lowest voltage among the plurality of battery cells 10 when the voltage deviation is greater than or equal to the reference value may be sensed at step S550. In an embodiment, the present disclosure may further include step S533 of determining whether the voltage deviation of the plurality of battery cells 10 is greater than or equal to an error value.

According to the present disclosure, after step S550 of sensing the minimum voltage cell, step 570 of determining whether the minimum voltage cell is included in the plurality of sensing units 30 may be performed.

The present disclosure may further include step S571 of changing the sensing unit 30 including the minimum voltage cell to another sensing unit 30 when the minimum voltage cell is included in the plurality of sensing units 30. The present disclosure may supply power to the second external device 120 by changing the sensing units 30. Further, the present disclosure may change the sensing unit 30, to which the minimum voltage cell belongs, to another sensing unit 30 in accordance with a predetermined order of changing the sensing units 30 at step S500.

The present disclosure may further include step S500 of changing the low-voltage unit 40 to another low-voltage unit 40 when the minimum voltage cell is included in the plurality of low-voltage units 40. By changing the low-voltage unit 40, the present disclosure may supply power to the first external device 110.

In the present disclosure, the low-voltage unit 40 including the minimum voltage cell may be changed to another low-voltage unit 40 according to the predetermined order of changing the low-voltage units 40 at step S500.

Referring to FIG. 5, the sequence of the battery control method of the present disclosure will be described in detail.

First, a low-voltage unit M_{X}U_{y} (y≠1) connected to one of the battery modules 20 may supply power to the first external device 110. At the same time, a sensing unit MₓU₁ connected to one of the battery modules 20 may supply power to the first external device 110. While the low-voltage unit 40 and the sensing unit 30 are supplying power, the control portion 70 may sense the voltages of the plurality of battery cells 10.

The present disclosure may calculate a voltage deviation of the plurality of battery cells 10 based on the sensed voltages, and may then determine whether the voltage deviation is greater than or equal to a reference value. When the voltage deviation is greater than or equal to the reference value, a minimum voltage cell may be sensed. When the voltage deviation of the plurality of battery cells 10 is greater than or equal to an error value, the battery may be controlled according to the predetermined method.

Subsequently, according to the present disclosure, it may be determined whether the minimum voltage cell belongs to the low-voltage unit M_{X}U_{y} (y≠1) or the sensing unit M_{X}U₁. When the minimum voltage cell belongs to the sensing unit 30, according to the present disclosure, the presence of another sensing unit Mₓ₊₁U₁ may be checked. Another sensing unit Mₓ₊₁U₁ may refer to an unused sensing unit 30.

Specifically, the battery modules may be sequentially ordered from a first battery module M1 to an Nth battery module MN. In the same way, the sensing units may be sequentially ordered from a first sensing unit M₁U₁ connected to the first battery module M1 to an Nth sensing unit M₁U_{N} connected to the Nth battery module MN.

When the first sensing unit M₁U₁ is determined to include a minimum voltage cell and a second sensing unit M₂U₁ is present, and the second sensing unit M₂U₁ may supply power to the second external device 120. However, when there is no longer any sensing unit 30 which is not used because all the sensing units are used up to the Nth sensing unit M_{N}N₁ due to continued use, the first sensing unit M₁U₁ which is initially used may supply power again to the second external device 120. In this way, the sensing units may be changed.

When the minimum voltage cell belongs to the low-voltage unit 40, the present disclosure may check the presence of another low-voltage unit 40. Another low-voltage unit 40 may refer to an unused low-voltage unit 40.

The predetermined order of changing the predetermined low-voltage units may be different from the predetermined order of changing sensing units because a plurality of predetermined voltage units may be provided in each battery module 20 while a single predetermined sensing unit 30 may be provided in each battery module 20.

First, the low-voltage units may be sequentially ordered from a first low-voltage unit M₁U₂ connected to the first battery module M₁ to an Nth low-voltage unit M₁U_{N+1}. When the first low-voltage unit M₁U₂ is determined to include a minimum voltage cell and a second low-voltage unit M₁U₃ is present, the second low-voltage unit M₁U₃ may supply power to the first external device 110. When the low-voltage unit 40 which is not used is no longer present in one battery module (the first battery module M₁) of the battery modules, the presence of another battery module (M₂) may be checked.

When another battery module M₂ is present, a first low-voltage unit M₂U₂ of another battery module may supply power to the second external device 120. In another battery module, the low-voltage unit 40 may be changed from the first low-voltage unit M₂U₂ to an Nth low-voltage unit M₂U_{N} according to the predetermined order of changing the low-voltage units.

In the same way, after the low-voltage units 40 in all battery modules are used once, the first low-voltage unit M₁U₂ of the first battery module M1 may again supply power to the first external device 110.

According to an embodiment of the present disclosure, a battery control system and a battery control method can be provided wherein a vehicle can be lightweight and performance can be improved.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery control system, comprising:
a high-voltage output portion including a plurality of battery cells;
a plurality of sensing units formed by grouping a portion of the plurality of battery cells into a predetermined number of groups□
a plurality of low-voltage units formed by grouping another portion of the plurality of battery cells into a predetermined number of groups, except for the plurality of sensing units;
a switching portion connecting the plurality of low-voltage units and a first external device; and
a control portion changing one of the plurality of sensing units to another sensing unit, or changing one of the plurality of low-voltage units to another low-voltage unit, based on at least one of a voltage, a capacity, and a usage time of the plurality of battery cells,
wherein the plurality of sensing units supply power to a second external device different from the first external device.

2. The battery control system according to claim 1, wherein the control portion changes one of the plurality of sensing units to another sensing unit, or changes one of the plurality of low-voltage units to another low-voltage unit when a voltage deviation of the plurality of battery cells is greater than or equal to a reference value.

3. The battery control system according to claim 2, wherein the control portion determines whether a minimum voltage cell having a lowest voltage among the plurality of battery cells is included in the plurality of sensing units.

4. The battery control system according to claim 3, wherein the control portion changes a sensing unit to which the minimum voltage cell with the lowest voltage among the plurality of battery cells belongs to another sensing unit to supply power to the first external device when the minimum voltage cell belongs to the plurality of sensing units.

5. The battery control system according to claim 4, wherein the control portion changes the sensing unit to which the minimum voltage cell belongs to another sensing unit according to a predetermined sensing unit changing order.

6. The battery control system according to claim 3, wherein the control portion changes a low-voltage unit to which the minimum voltage cell with the lowest voltage among the plurality of battery cells to another low-voltage unit to supply power to the second external device when the minimum voltage cell belongs to the plurality of low-voltage units.

7. The battery control system according to claim 6, wherein the control portion changes the low-voltage unit to which the minimum voltage cell belongs to another low-voltage unit according to a predetermined low-voltage unit changing order.

8. A battery control method of a battery control system including a high-voltage output portion including a plurality of battery cells; a plurality of sensing units formed by grouping a portion of the plurality of battery cells into a predetermined number of groups; a plurality of low-voltage units formed by grouping another portion of the plurality of battery cells into a predetermined number of groups, except for the plurality of sensing units; a switching portion connecting the plurality of low-voltage units and a first external device; and a control portion changing one sensing unit among the plurality of sensing units to another sensing unit, or changing one low-voltage unit among the plurality of low-voltage units to another low-voltage unit, based on at least one of a voltage, a capacity, and a usage time of the plurality of battery cells,
wherein the plurality of sensing units supply power to a second external device different from the first external device, the battery control method, comprising:
supplying power to the first external device by the one low-voltage unit among the plurality of low-voltage units;
supplying power to the second external device by the one sensing unit among the plurality of sensing units; and
changing the one low-voltage unit connected to the first external device to another low-voltage unit, or changing the one sensing unit connected to the second external device to another sensing unit, based on at least one of a voltage, a capacity, and a usage time of the plurality of battery cells.

9. The battery control method according to claim 8, wherein the changing comprises: determining whether a voltage deviation of the plurality of battery cells is greater than or equal to a reference value; sensing a minimum voltage cell having a lowest voltage among the plurality of battery cells; and determining whether the minimum voltage cell is included in the plurality of sensing units.

10. The battery control method according to claim 9, wherein the changing further comprises changing a sensing unit to which the minimum voltage cell belongs to another sensing unit when the minimum voltage cell is included in the plurality of sensing units.

11. The battery control method according to claim 10, wherein the changing comprises changing the sensing unit to which the minimum voltage cell belongs to another sensing unit according to a predetermined sensing unit changing order.

12. The battery control method according to claim 9, wherein the changing further comprises changing a low-voltage unit to which the minimum voltage cell belongs to another sensing unit when the minimum voltage cell is included in the plurality of low-voltage units.

13. The battery control method according to claim 12, wherein the changing comprises changing a low-voltage unit to which the minimum voltage cell belongs to another low-voltage unit according to a predetermined low-voltage unit changing order.
